(19) United States
(12) Patent Application Publication
(10) Pub. No.: US 2010/0268800 A1
(43) Pub. Date: Oct. 21, 2010

(54) METHOD AND APPARATUS FOR CONFIGURING NETWORK-ATTACHED STORAGE

(76) Inventors: Shih-Jen Lu, Taipei County (TW); Chun-Hung Kuo, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/617,702

(22) Filed: Nov. 12, 2009

(30) Foreign Application Priority Data
Apr. 20, 2009 (TW) 098113028

(51) Int. Cl. G06F 15/177; G06F 13/00

(52) U.S. Cl. 709/220; 710/104

(57) ABSTRACT

A method for configuring a network-attached storage (NAS) includes: coupling the network-attached storage to a user-end personal computer (PC) via an external bus which supports a plug & play function; and utilizing the user-end PC to configure a network interface of the NAS via the external bus. A network-attached storage (NAS) includes a network interface, a bus interface, and processor. The network interface is for connecting with a network. The bus interface is for connecting with an external bus which supports a plug & play function and for receiving network interface setting parameters outputted by a user-end PC via the external bus. The processor is coupled between the network interface and the bus interface, and implemented for configuring the network interface according to the network interface setting parameters received by the bus interface.

### BACKGROUND OF THE INVENTION

1. Field of the Invention

The present invention relates to a network storage system, and more particularly, to a method and apparatus for configuring a network-attached storage.

2. Description of the Prior Art

A network-attached storage (NAS) is a file-level computer data storage connected to a network, for providing data access to heterogeneous network clients. The NAS is directly connected to a local area network (LAN), and supports multiple file-based protocols. Please refer to FIG. 1. FIG. 1 is a diagram illustrating a conventional NAS system 100. As shown in FIG. 1, a NAS 110 is connected to a user-end personal computer (PC) 130 via an Ethernet 120. The NAS 110 is connected to the user-end PC 130 or other developed dedicated file servers via the Ethernet 120, for managing the data files stored on a network and providing the common data storage protocols between different servers and workstations based on the internet protocol (IP). Because the NAS (serving as a file server) is optimized and dedicated to providing storage services, other servers can run tasks without allocating system resources to provide the storage services. One of the major advantages of the NAS is that the NAS can allocate storage space to different servers and workstations, and the data files can be shared on the network. Unlike the conventional storage area network (SAN) which can transmit the data files block by block, however, the data stored in the NAS can only be transmitted via separate files.

The difference between the NAS and a conventional data storage service or a direct storage apparatus is that the operating system (OS) and software of the NAS only provides the functionality of data storage, file systems, access to files, and the management of these functionalities. Additionally, the NAS usually contains one or more hard disks, often arranged into logical, redundant storage containers or RAID arrays (Redundant Arrays of Inexpensive/Independent Disks). The NAS uses file-based protocols such as network file system (NFS) or server message block (SMB).

Because the NAS provides data access service via the network, the prior art design performs an initialization setup to configure the NAS via an Ethernet interface. However, it is difficult to connect to the NAS via the Ethernet interface when the configuration of the network is not completed yet. Therefore, how to configure the NAS easily and effectively is an urgent issue that needs to be resolved.

### SUMMARY OF THE INVENTION

It is therefore one of the objectives of the present invention to provide a method for configuring with a network-attached storage (NAS) and a related apparatus, in order to solve the above-mentioned problems.

According to an embodiment of the present invention, a method for configuring a NAS is disclosed. The method includes: coupling the NAS to a user-end personal computer (PC) via an external bus which supports a plug & play function; and utilizing the user-end PC to configure a network interface of the NAS via the external bus. In addition, the method further configures other function(s) of the NAS through the network via the network interface of the NAS after the network interface of the NAS is configured successfully.

According to another embodiment of the present invention, a NAS is disclosed. The NAS includes a network interface, a bus interface and a processor. The network interface is used for connecting with a network. The bus interface is used for connecting with an external bus which supports a plug & play function, and for receiving network interface setting parameters outputted by a user-end PC via the external bus. The processor is coupled between the network interface and the bus interface, and implemented for configuring the network interface according to the network interface setting parameters received by the bus interface. Additionally, the network interface of the NAS further configures other function(s) of the NAS through the network after the network interface of the NAS is configured successfully.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional network-attached storage system.

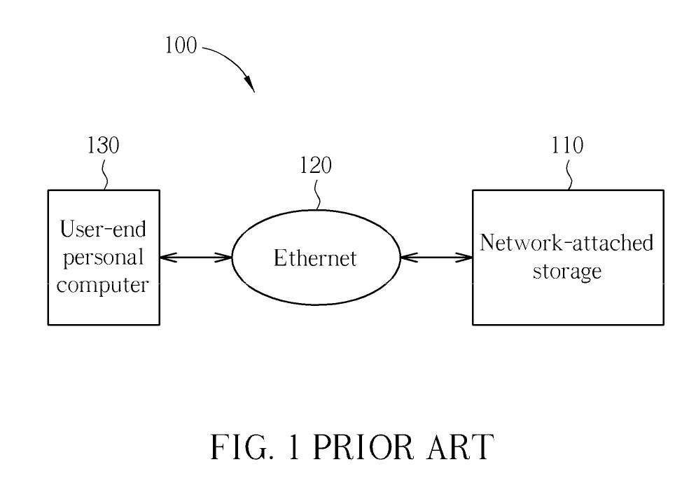

FIG. 2 is a diagram illustrating a network-attached storage system according to an exemplary embodiment of the present invention.

FIG. 3 is a flowchart illustrating a method for configuring a network-attached storage system shown in FIG. 2 according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

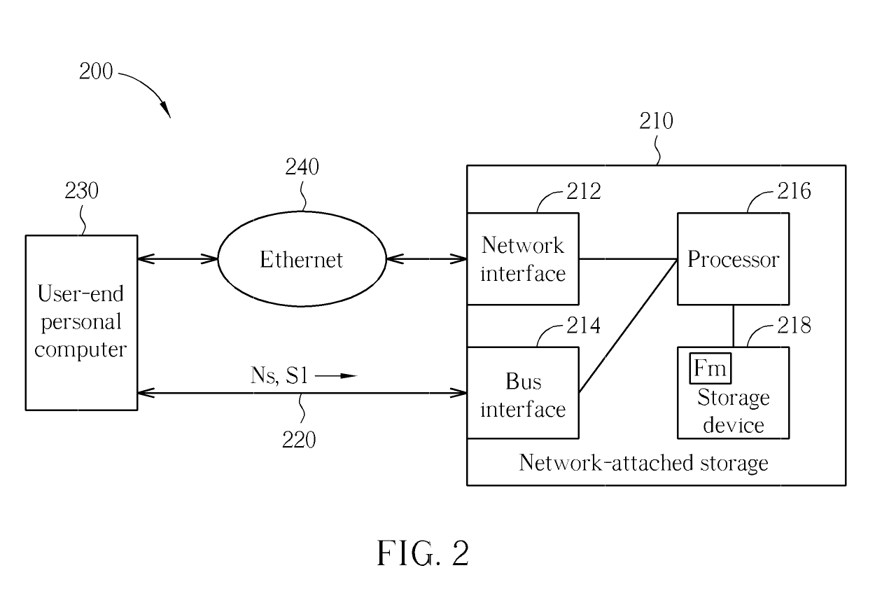

Please refer to FIG. 2. FIG. 2 is a diagram illustrating a network-attached storage (NAS) system 200 according to an exemplary embodiment of the present invention. In this embodiment, the NAS system 200 includes, but is not limited to, a NAS 210, a universal serial bus (USB) 220, a user-end personal computer (PC) 230 and an Ethernet 240. Please note that the USB 220 is an external bus which supports a plug & play function in this exemplary embodiment; however, this is for illustrative purposes only, and is by no means to serve as a limitation to the scope of the present invention. Using another external bus (e.g. IEEE 1394 bus) that also supports the plug & play function also falls within the scope of the present invention. The NAS 210 includes a network interface 212, a bus interface 214 and a processor 216. The network interface 212 is used for connecting with the Ethernet 240. The bus interface 214 is used for connecting with the USB 220 in order to receive the network interface setting parameters S1 outputted by the user-end PC 230 via the USB 220. The processor 216 is coupled between the network interface 212 and the bus interface 214, for configuring the network interface 212 according to the network interface setting parameters S1 received by the bus interface 214.

The NAS 210 further includes an internal firmware Fm and a storage device 218. The storage device 218 is coupled to the processor 216, for storing data and the internal firmware Fm. The processor 216 is implemented to execute the internal firmware Fm to detect if the NAS system software is installed in the NAS. When the internal firmware Fm executed by the processor 216 finds that the NAS system software Ns is not installed in the NAS 210, the processor 216 executes the internal firmware Fm to receive the NAS system software Ns from the user-end PC 230 via the USB 220, and installs the NAS system software Ns into the storage device 218. The processor 216 executes the NAS system software Ns to configure the network interface 212 according to the network interface setting parameters S1 when the NAS system software Ns has been installed in the NAS 210. Furthermore, the network interface 212 of the NAS 210 configures other function(s) of the NAS 210 through the Ethernet 240 after the network interface 212 of the NAS 210 is configured successfully.

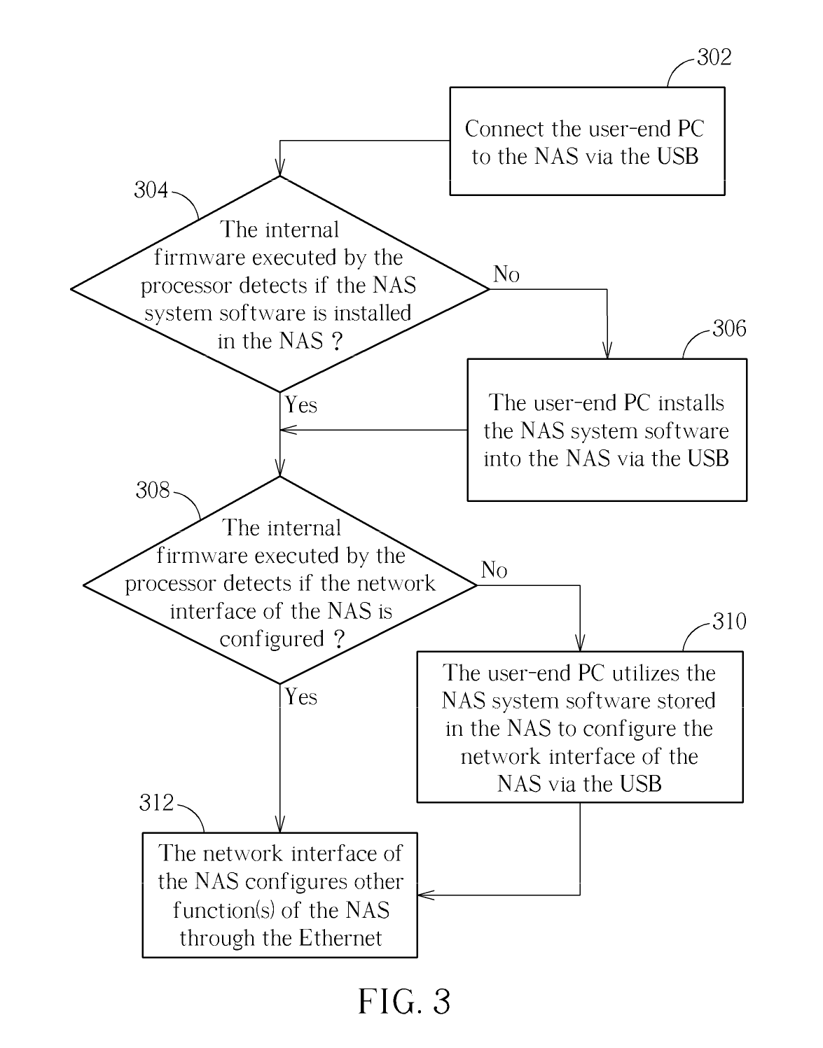

Please refer to FIG. 3 in conjunction with FIG. 2. FIG. 3 is a flowchart illustrating a method for configuring the network-attached storage system 200 shown in FIG. 2 according to an exemplary embodiment of the present invention. Please note that, provided the same result is substantially achieved, the steps of the flow shown in FIG. 3 need not be in the exact order shown and need not be contiguous; that is, other steps can be intermediate. The exemplary method for configuring the network-attached storage system 200 includes the following steps:

Step 302: Connect the user-end PC 230 to the NAS 210 via the USB 220.

Step 304: The internal firmware Fm executed by the processor 216 detects if the NAS system software Ns is installed in the NAS 210. If yes, go to step 308; otherwise, go to step 306.

Step 306: The user-end PC 230 installs the NAS system software Ns into the NAS 210 via the USB 220.

Step 308: The internal firmware Fm executed by the processor 216 detects if the network interface 212 of the NAS 210 is configured. If yes, go to step 312; otherwise, go to step 310.

Step 310: The user-end PC 230 utilizes the NAS system software Ns stored in the NAS 210 to configure the network interface 212 of the NAS 210 via the USB 220.

Step 312: The network interface 212 of the NAS 210 configures other function(s) of the NAS 210 through the Ethernet 240.

In step 312, when the network interface 212 of the NAS 210 can not configure other function(s) of the NAS 210 through the Ethernet 240 (i.e. the network connection breaks off), the user-end PC 230 can perform a simple data transmission operation with the NAS 210 via the USB 220 such that the user-end PC 230 will not totally lose contact with the NAS 210.

In summary, the present invention provides a method and related apparatus for configuring a NAS. Since the present invention utilizes an external bus which supports a plug & play function to connect a user-end PC and a NAS, the configuration problem of the NAS is solved. The external bus can be used to configure the network interface of the NAS before the network interface of the NAS is successfully configured. In this way, the complex step of configuring the network interface of the NAS via the Ethernet can be averted.

Those skilled in the art will readily observe that numerous modifications and alterations of the device and method may be made while retaining the teachings of the invention.

What is claimed is:

1. A method for configuring a network-attached storage (NAS), comprising:
coupling the network-attached storage to a user-end personal computer (PC) via an external bus which supports a plug & play function; and
utilizing the user-end PC to configure a network interface of the NAS via the external bus.

2. The method of claim 1, wherein the external bus is a universal serial bus (USB).

3. The method of claim 1, wherein the external bus is an IEEE 1394 bus.

4. The method of claim 1, further comprising:
utilizing the user-end PC to install a NAS system software into the NAS via the external bus when an internal firmware executed by the NAS detects that the NAS system software is not installed in the NAS;
and the step of the user-end PC configuring the network interface of the NAS via the external bus comprises:
utilizing the user-end PC to operate the NAS system software stored in the NAS for configuring the network interface of the NAS via the external bus.

5. The method of claim 1, further comprising:
utilizing the network interface of the NAS to configure other function(s) of the NAS through the network after the network interface of the NAS is configured successfully.

6. A network-attached storage (NAS), comprising:
a network interface, for connecting with a network;
a bus interface, for connecting with an external bus which supports a plug & play function, and for receiving network interface setting parameters outputted by a user-end PC via the external bus; and
a processor, coupled between the network interface and the bus interface, for configuring the network interface according to the network interface setting parameters received by the bus interface.

7. The NAS of claim 6, wherein the external bus is a universal serial bus (USB).

8. The NAS of claim 6, wherein the external bus is an IEEE 1394 bus.

9. The NAS of claim 6, further comprising:
an internal firmware; and
a storage device;
wherein the processor executes the internal firmware to detect if a NAS system software is installed in the NAS; when the internal firmware executed by the processor detects that the NAS system software is not installed in the NAS, the processor further executes the internal firmware to receive the NAS system software from the user-end PC via the external bus and install the NAS system software into the storage device; and the processor executes the NAS system software to configure the network interface according to the network interface setting parameters.

10. The NAS of claim 6, wherein the network interface of the NAS configures other function(s) of the NAS through the network after the network interface of the NAS is configured successfully.
